(19) United States
(12) Patent Application Publication
(10) Pub. No.: US 2026/0361361 A1
(43) Pub. Date: Nov. 12, 2026

(54) SOUNDING REFERENCE SIGNAL-FREE UPLINK TRANSMISSION PROCEDURES

(71) Applicant: QUALCOMM Incorporated, San Diego, CA (US)

(72) Inventors: Hyojin LEE, San Diego, CA (US); Yu ZHANG, San Diego, CA (US); Jing SUN, San Diego, CA (US)

(21) Appl. No.: 19/655,594

(22) Filed: Apr. 22, 2026

Related U.S. Application Data
(60) Provisional application No. 63/801,684, filed on May 7, 2025.

(51) Int. Cl. H04B 7/06; H04W 72/1268

(52) U.S. Cl. CPC H04B 7/0626; H04B 7/0632; H04W 72/1268

(57) ABSTRACT

This disclosure provides methods, components, devices and systems for SRS-free uplink transmission procedures. In some cases, a user equipment (UE) may receive, over a downlink channel, one or more channel state information reference signals (CSI-RSs). Additionally, the UE may transmit, in response to the one or more CSI-RSs, CSI feedback for an uplink channel having channel reciprocity with the downlink channel, where the CSI feedback is generated based on an uplink channel matrix derived from measurement of the one or more CSI-RSs. Further, the UE may receive an uplink grant for the uplink channel that indicates uplink precoding information and one or more modulation and coding schemes (MCSs) to be used by the UE for one or more uplink transmissions. In such cases, the uplink precoding information and one or more MCSs may be in accordance with the CSI feedback.

### CROSS REFERENCE

The present Application for Patent claims the benefit of U.S. Provisional Patent Application No. 63/801,684 by LEE et al., entitled “SOUNDING REFERENCE SIGNAL-FREE UPLINK TRANSMISSION PROCEDURES,” filed May 7, 2025, assigned to the assignee hereof, and expressly incorporated by reference herein.

### TECHNICAL FIELD

This disclosure relates generally to wireless communication, and more specifically to systems, devices, methods, and techniques associated with a sounding reference signal-free (SRS-free) uplink transmission procedure.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a UE is described. The method may include receiving, over a downlink channel, one or more channel state information (CSI) reference signals (CSI-RSs), transmitting, in response to reception of the one or more CSI-RSs, CSI feedback for an uplink channel having channel reciprocity with the downlink channel, where the CSI feedback is generated based on an uplink channel matrix derived from measurement of the one or more CSI-RSs, and receiving an uplink grant for the uplink channel that indicates uplink precoding information and one or more modulation and coding schemes (MCSs) to be used by the UE for one or more uplink transmissions, where the uplink precoding information and one or more MCSs are in accordance with the CSI feedback.

A UE for wireless communications is described. The UE may include a processing system that includes processor circuitry and memory circuitry that stores code. The processing system may be configured to cause the UE to receive, over a downlink channel, one or more CSI-RSs, transmit, in response to reception of the one or more CSI-RSs, CSI feedback for an uplink channel having channel reciprocity with the downlink channel, where the CSI feedback is generated based on an uplink channel matrix derived from measurement of the one or more CSI-RSs, and receive an uplink grant for the uplink channel that indicates uplink precoding information and one or more MCSs to be used by the UE for one or more uplink transmissions, where the uplink precoding information and one or more MCSs are in accordance with the CSI feedback.

Another UE for wireless communications is described. The UE may include means for receiving, over a downlink channel, one or more CSI-RSs, means for transmitting, in response to reception of the one or more CSI-RSs, CSI feedback for an uplink channel having channel reciprocity with the downlink channel, where the CSI feedback is generated based on an uplink channel matrix derived from measurement of the one or more CSI-RSs, and means for receiving an uplink grant for the uplink channel that indicates uplink precoding information and one or more MCSs to be used by the UE for one or more uplink transmissions, where the uplink precoding information and one or more MCSs are in accordance with the CSI feedback.

A non-transitory computer-readable medium storing code for wireless communications is described. The code may include instructions executable by one or more processors to receive, over a downlink channel, one or more CSI-RSs, transmit, in response to reception of the one or more CSI-RSs, CSI feedback for an uplink channel having channel reciprocity with the downlink channel, where the CSI feedback is generated based on an uplink channel matrix derived from measurement of the one or more CSI-RSs, and receive an uplink grant for the uplink channel that indicates uplink precoding information and one or more modulation and coding schemes (MCSs) to be used by the UE for one or more uplink transmissions, where the uplink precoding information and one or more MCSs are in accordance with the CSI feedback.

Some examples of the method, UEs, and non-transitory computer-readable medium described herein may further include operations, features, means, or instructions for calculating an uplink precoding matrix based on the uplink channel matrix and calculating a per-layer reference signal receive power (RSRP) for each layer of a set of multiple layers, the CSI feedback further including an indication of a set of multiple per-layer RSRPs for the set of multiple layers.

In some examples of the method, UEs, and non-transitory computer-readable medium described herein, the CSI feedback further includes an indication of the uplink precoding matrix.

Some examples of the method, UEs, and non-transitory computer-readable medium described herein may further include operations, features, means, or instructions for receiving an indication of an interference covariance matrix, where the interference covariance matrix may be based on one or more uplink signals transmitted by the UE and calculating one or more channel quality indicators (CQIs) in accordance with the uplink channel matrix and the interference covariance matrix, the CSI feedback further including an indication of the one or more CQIs.

In some examples of the method, UEs, and non-transitory computer-readable medium described herein, the uplink precoding information indicates a rank, a column of an uplink precoding matrix, or both, the one or more MCSs that are indicated via the uplink grant corresponding to the rank, the column, or both.

Some examples of the method, UEs, and non-transitory computer-readable medium described herein may further include operations, features, means, or instructions for receiving first configuration information indicative of a set of multiple CSI-RS resources, where each CSI-RS resource of the set of multiple CSI-RS resources corresponds to a different beam, a different transmission reception point, or both, and receiving second control information indicative of one or more CSI-RS resources from the set of multiple CSI-RS resources, where each CSI-RS of the one or more CSI-RSs may be received via a corresponding CSI-RS resource of the one or more CSI-RS resources.

In some examples of the method, UEs, and non-transitory computer-readable medium described herein, the CSI feedback may be obtained for the uplink channel in accordance with an SRS-free uplink transmission procedure and the method, apparatuses, and non-transitory computer-readable medium may include further operations, features, means, or instructions for receiving a control message that indicates the UE is to perform the SRS-free uplink transmission procedure, where reception of the one or more CSI-RSs may be in response to reception of the control message.

A method for wireless communications by a network entity is described. The method may include outputting, over a downlink channel, one or more CSI-RSs, obtaining, in response to transmission of the one or more CSI-RSs, CSI feedback for an uplink channel having channel reciprocity with the downlink channel, and outputting an uplink grant for the uplink channel that indicates uplink precoding information and one or more MCSs to be used by a UE for one or more uplink transmissions over the uplink channel, where the uplink precoding information and one or more MCSs are calculated in accordance with the CSI feedback.

A network entity for wireless communications is described. The network entity may include a processing system that includes processor circuitry and memory circuitry that stores code. The processing system may be configured to cause the network entity to output, over a downlink channel, one or more CSI-RSs, obtain, in response to transmission of the one or more CSI-RSs, CSI feedback for an uplink channel having channel reciprocity with the downlink channel, and output an uplink grant for the uplink channel that indicates uplink precoding information and one or more MCSs to be used by a UE for one or more uplink transmissions over the uplink channel, where the uplink precoding information and one or more MCSs are calculated in accordance with the CSI feedback.

Another network entity for wireless communications is described. The network entity may include means for outputting, over a downlink channel, one or more CSI-RSs, means for obtaining, in response to transmission of the one or more CSI-RSs, CSI feedback for an uplink channel having channel reciprocity with the downlink channel, and means for outputting an uplink grant for the uplink channel that indicates uplink precoding information and one or more MCSs to be used by a UE for one or more uplink transmissions over the uplink channel, where the uplink precoding information and one or more MCSs are calculated in accordance with the CSI feedback.

A non-transitory computer-readable medium storing code for wireless communications is described. The code may include instructions executable by one or more processors to output, over a downlink channel, one or more CSI-RSs, obtain, in response to transmission of the one or more CSI-RSs, CSI feedback for an uplink channel having channel reciprocity with the downlink channel, and output an uplink grant for the uplink channel that indicates uplink precoding information and one or more MCSs to be used by a UE for one or more uplink transmissions over the uplink channel, where the uplink precoding information and one or more MCSs are calculated in accordance with the CSI feedback.

In some examples of the method, network entities, and non-transitory computer-readable medium described herein, the CSI feedback includes an indication of a per-layer RSRP for each layer of a set of multiple layers.

In some examples of the method, network entities, and non-transitory computer-readable medium described herein, the CSI feedback further includes an indication of an uplink precoding matrix and the uplink precoding matrix may be based on an uplink channel matrix representative of the uplink channel.

Some examples of the method, network entities, and non-transitory computer-readable medium described herein may further include operations, features, means, or instructions for generating an interference covariance matrix, where the interference covariance matrix may be generated in accordance with one or more uplink signals obtained from the UE and outputting an indication of the interference covariance matrix, where the CSI feedback includes an indication of one or more CQIs, and where the one or more CQIs may be based on the interference covariance matrix.

In some examples of the method, network entities, and non-transitory computer-readable medium described herein, the uplink precoding information indicates a rank, a column of an uplink precoding matrix, or both, the one or more MCSs that are indicated via the uplink grant corresponding to the rank, the column, or both.

Some examples of the method, network entities, and non-transitory computer-readable medium described herein may further include operations, features, means, or instructions for outputting first configuration information indicative of a set of multiple CSI-RS resources, where each CSI-RS resource of the set of multiple CSI-RS resources corresponds to a different beam, a different transmission reception point, or both, and outputting second control information indicative of one or more CSI-RS resources from the set of multiple CSI-RS resources, where each CSI-RS of the one or more CSI-RSs may be output via a corresponding CSI-RS resource of the one or more CSI-RS resources.

In some examples of the method, network entities, and non-transitory computer-readable medium described herein, the CSI feedback may be obtained for the uplink channel in accordance with an SRS-free uplink transmission procedure and the method, apparatuses, and non-transitory computer-readable medium may include further operations, features, means, or instructions for transmitting a control message that indicates the UE is to perform the SRS-free uplink transmission procedure, where reception of the one or more CSI-RSs may be in response to reception of the control message.

Some examples of the method, network entities, and non-transitory computer-readable medium described herein may further include operations, features, means, or instructions for performing one or more measurements of the UE, where output of the control message may be in accordance with the one or more measurements satisfying one or more thresholds.

### BRIEF DESCRIPTION OF THE DRAWINGS

FIG. 1 shows an example of a wireless communication system.

FIGS. 2A and 2B show an example of a signaling diagram that supports sounding reference signal-free (SRS-free) uplink transmission procedures.

FIG. 3 shows an example of a process flow that supports SRS-free uplink transmission procedures.

FIG. 4 shows an example of a process flow that supports SRS-free uplink transmission procedures.

FIG. 5 shows an example of a process flow that supports SRS-free uplink transmission procedures.

FIG. 6 shows a block diagram of a processing system that supports SRS-free uplink transmission procedures.

FIG. 7 shows a diagram of a system including a device that supports SRS-free uplink transmission procedures.

FIG. 8 shows a block diagram of a processing system that supports SRS-free uplink transmission procedures.

FIG. 9 shows a diagram of a system including a device that supports SRS-free uplink transmission procedures.

FIGS. 10 and 11 show flowcharts illustrating methods that support SRS-free uplink transmission procedures.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

Some wireless communications systems may support multiple input multiple output (MIMO) communications in which a user equipment (UE), a network entity, or both, may use multiple antennas to communicate data. In such cases, the UE, the network entity, or both, may support multiple uplink MIMO modes. For example, a first uplink MIMO mode (e.g., Mode 1) may be codebook-based MIMO and a second uplink MIMO mode (e.g., Mode 2) may be non-codebook-based MIMO. For both uplink MIMO modes, the UE may transmit one or more sounding reference signals (SRSs) to the network entity to enable the network entity to determine precoding information, a modulation and coding scheme (MCS), or both, for one or more uplink transmissions (e.g., physical uplink shared channel (PUSCH) transmissions) to be performed by the UE. However, the one or more SRSs may be transmitted periodically with a relatively long period (e.g., 40 milliseconds (ms), 80 ms, or more), such that a channel state information acquisition delay may exist based on the period of the one or more SRSs. In some cases, to reduce the CSI acquisition delay, the UE may transmit the one or more SRSs aperiodically or semi-persistently, however, transmitting the one or more SRSs aperiodically or semi-persistently may result in increased signaling and overhead. Additionally, or alternatively, for a cell-edge UE, a channel estimation accuracy of the one or more SRSs may not be reliable enough (e.g., may not exceed a threshold reliability) for the network entity to derive accurate precoding information due to a lack of transmit (Tx) power of the cell-edge UE, due to a wideband property of the one or more SRSs, or both.

Aspects of the subject matter described in this disclosure relate to an SRS-free uplink transmission procedure in which channel information, such as an uplink channel matrix, determined by the UE and interference information, such as a noise-plus-interference covariance matrix (e.g., an interference matrix), determined by the network entity may be used (e.g., by the UE, the network entity, or both) to determine uplink precoding information, an MCS, or both, for one or more uplink transmissions (e.g., PUSCH transmissions) to be performed by the UE. In other words, the uplink precoding information, the MCS, or both, may be determined without the use of one or more SRSs (e.g., in an absence of transmission of the one or more SRSs). For example, the UE may transmit one or more uplink signals to the network entity, such that the network entity may perform one or more interference measurements, one or more noise measurements, or both, based on the one or more uplink signals to generate a noise-plus-interference covariance matrix (e.g., Rₙₙ). Additionally, the network entity may transmit, to the UE via a downlink channel, one or more CSI reference signals (CSI-RS), such that the UE may generate (e.g., calculate, determine) an uplink channel matrix for an uplink channel, that has channel reciprocity with the downlink channel, based on measurement of the one or more CSI-RS.

The UE may additionally calculate an uplink precoding matrix and, based on the uplink precoding matrix, a reference signal receive power (RSRP) for each layer of multiple layers configured for the UE, which may be referred to as per-layer RSRPs. In some examples, the UE may transmit, via uplink CSI feedback, an indication of the uplink precoding matrix and an indication of the per-layer RSRPs. In such cases, the network entity may determine the uplink precoding information, the MCS, or both, based on the uplink precoding matrix and the per-layer RSRPs, and may transmit, to the UE via an uplink grant, an indication of the uplink precoding information, the MCS, or both. Alternatively, the UE may transmit, via the uplink CSI feedback, the indication of the per-layer RSRPs, where the uplink precoding matrix is absent from the uplink CSI feedback. In such cases, the network entity may determine the uplink precoding information, the MCS, or both, based on the per-layer RSRPs, and may transmit, to the UE via an uplink grant, an indication of the uplink precoding information, the MCS, or both.

Additionally, or alternatively, the network entity may transmit, to the UE, an indication of the noise-plus-interference covariance matrix. In such cases, the UE may calculate one or more channel quality indicators (CQIs) based on the noise-plus-interference covariance matrix and the uplink channel matrix and may transmit, via the uplink CSI feedback, an indication of the one or more CQIs. In some cases, the one or more CQIs may include multiple CQIs, where each CQI of the multiple CQIs may correspond to a rank assumption of multiple rank assumptions. Additionally, or alternatively, the uplink CSI feedback indicating the one or more CQIs may also indicate the uplink precoding matrix calculated by the UE. Thus, the network entity may determine the uplink precoding information, the MCS, or both, based on the one or more CQIs (e.g., and optionally the uplink precoding matrix), and may transmit, to the UE via an uplink grant, an indication of the uplink precoding information, the MCS, or both.

Particular aspects of the subject matter described in this disclosure can be implemented to realize one or more of the following potential advantages. In some examples, by supporting the SRS-free uplink transmission procedure, the described techniques can be used to increase an accuracy of link adaptation, precoding adaptation, or both, due to the one or more CSI-RS being more reliable than the one or more SRSs (e.g., due to the network entity supporting a higher Tx power than the UE). Additionally, or alternatively, by supporting the SRS-free uplink transmission procedure, the described techniques can be used to reduce overhead of SRS transmission (e.g., avoid overhead due to aperiodic or semi-persistent (SP) SRS).

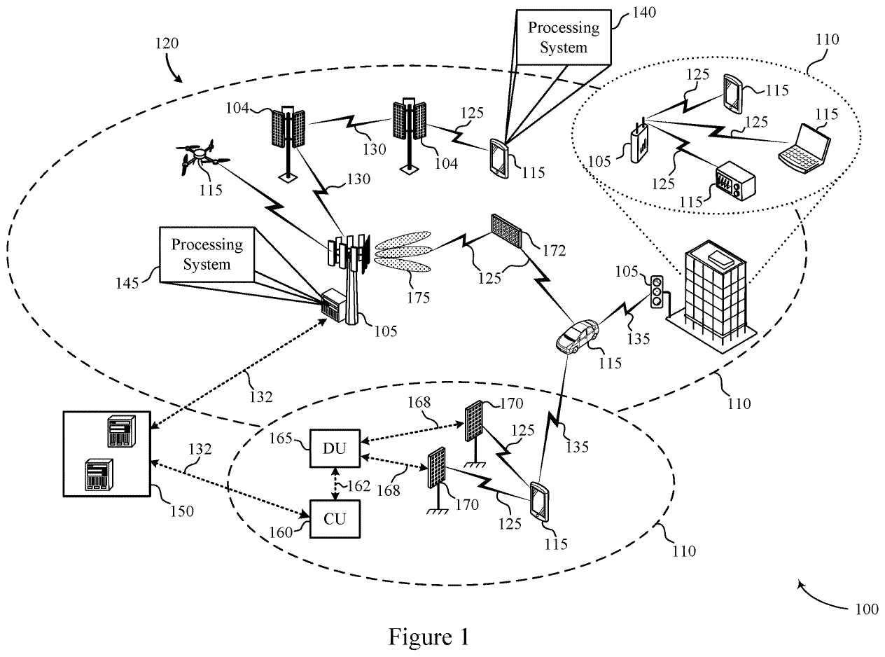

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHZ), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

In some cases, a singular value decomposition (SVD) of a channel matrix, such as an uplink channel matrix, H, may be represented according to the following Equation 1:

H=UΣV^{†} (1)

where U may represent a left singular matrix Nᵣ×Nₜ, V may represent a right singular matrix Nₜ×Nₜ, Σ may represent a diagonal matrix Nₜ×Nₜ with ordered singular values (σ₁≥σ₂≥ . . . ≥σ_{N}_{ₜ}), Nᵣ may represent a quantity (e.g., number) of receive antennas at a network entity 105, and Nₜ may represent a quantity of transmit antennas at a UE 115.

Additionally, a Rank-r unitary precoding matrix (e.g., optimal unitary precoding matrix) may be represented according to

$$\frac{1}{\sqrt{r}} {V}_{r} ,$$

where Wie Rank-r unitary precoding matrix may be an Nₜ×r matrix with the first r columns of V.

In some cases, a network entity 105 may determine a rank, R*, according to the following Equation 2:

$${R}^{*} = arg {max}_{r ∈ \{ 1 , 2 , … , R \}} {\sum }_{i = 1}^{r} S {E}_{est} ( \frac{{σ}_{i}^{2}}{r} ) \qquad ( 2 )$$

Additionally, or alternatively, the network entity 105 may determine a CQI, CQI*, according to the following Equation 3:

$${CQI}^{*} = f ( {\sum }_{i = 1}^{r} S {E}_{est} ( \frac{{σ}_{i}^{2}}{r} ) ) \qquad ( 3 )$$

Where SEₑₛₜ( ) may be a spectral efficiency estimation function and

$${σ}_{i}^{2}$$

may be an i-th singular value which represents a signal to noise ratio (SNR) or a signal to interference-plus-noise ratio (SINR) of the i-th layer. In some examples, per-layer SNR, per-layer SINR, or both, may be a parameter for rank determination, CQI determination, or both, for MIMO.

Devices of the wireless communication system 100 may be configured to support one or more aspects of the described techniques for SRS-free uplink transmission procedures. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support an SRS-free uplink transmission procedure. Additionally, by supporting the SRS-free uplink transmission procedure, the described techniques can be used to increase an accuracy of link adaptation, precoding adaptation, or both, due to one or more CSI-RS (e.g., transmitted during the SRS-free uplink transmission procedure) being more reliable than one or more SRSs (e.g., due to a network entity 105 supporting a higher Tx power than a UE 115). Additionally, or alternatively, by supporting the SRS-free uplink transmission procedure, the described techniques can be used to reduce overhead of SRS transmission.

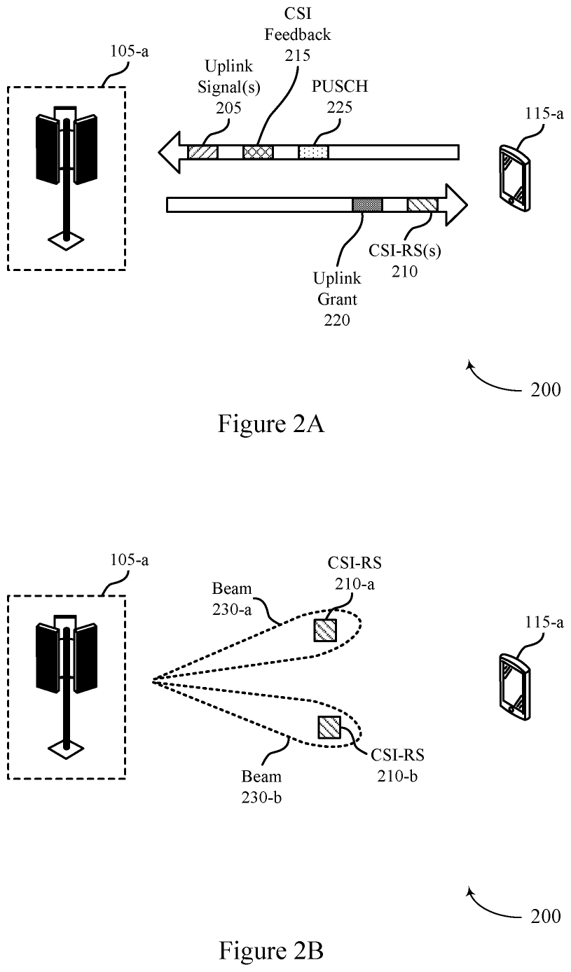

FIGS. 2A and 2B show an example of a signaling diagram 200 that supports uplink transmission procedures. In some cases, the signaling diagram 200 may implement or be implemented by aspects of the wireless communications system 100. For example, the signaling diagram 200 may include one or more UEs 115 (e.g., a UE 115-a) and one or more network entities 105 (e.g., a network entity 105-a), which may be examples of the corresponding devices as described herein.

Some wireless communications systems (e.g., NR) may support MIMO communications and, in some cases, may support multiple uplink MIMO modes. For example, a first uplink MIMO mode (e.g., Mode 1) may be codebook-based MIMO and a second uplink MIMO mode (e.g., Mode 2) may be non-codebook-based MIMO. In some cases, a UE 115, such as the UE 115-a, may support a first SRS-based uplink transmission procedure in accordance with the first uplink MIMO mode. In such cases, the UE 115-a may transmit one or more SRSs to a network entity 105, such as the network entity 105-a, and the network entity 105-a may determine precoding information, an MCS, or both, for one or more uplink transmissions (e.g., PUSCH transmissions) to be performed by the UE 115-a based on the one or more SRSs. Additionally, the network entity 105-a may transmit, to the UE 115-a, an uplink grant for the one or more uplink transmissions, where the uplink grant indicates the precoding information, the MCS, or both, such that the UE 115-a may perform the one or more uplink transmissions in accordance with the uplink grant, the precoding information, the MCS, or any combination thereof.

Additionally, or alternatively, the UE 115-a may support a second SRS-based uplink transmission procedure in accordance with the second uplink MIMO mode. In such cases, the network entity 105-a may transmit one or more CSI-RSs 210 to the UE 115-a and the UE 115-a may derive first precoding information (e.g., optimal precoding) based on the one or more CSI-RSs 210. Thus, the UE 115-a may transmit one or more precoded SRSs (e.g., SRSs precoded in accordance with the first precoding information) to the network entity 105-a, such that the network entity 105-a may determine second precoding information (e.g., column selection), an MCS, or both, for one or more uplink transmissions (e.g., PUSCH transmissions) to be performed by the UE 115-a based on the one or more precoded SRSs. Additionally, the network entity 105-a may transmit, to the UE 115-a, an uplink grant for the one or more uplink transmissions, where the uplink grant indicates an SRS resource indicator (SRI) to indicate the second precoding information, the MCS, or both, such that the UE 115-a may perform the one or more uplink transmissions in accordance with the uplink grant, SRI, the MCS, or any combination thereof. For both the first MIMO mode and the second MIMO mode, the UE 115-a may update uplink CSI once the one or more SRSs (e.g., one or more precoded SRSs) are transmitted by the UE 115-a.

However, the one or more SRSs may be periodic, such that the UE 115-a may transmit the one or more SRSs in accordance with a relatively long period (e.g., 40 ms, 80 ms, or more), resulting in a CSI acquisition delay. Conversely, a shorter SRS period (e.g., <20 ms) may be associated with increased complexity due to increased overhead and multiplexing between multiple UEs 115. In some cases, the network entity 105-a may trigger (e.g., activate) aperiodic SP SRS to reduce the CSI acquisition delay. However, triggering aperiodic or SP SRS may result in increased signaling and overhead.

Additionally, in some wireless communications systems (e.g., NR and LTE), uplink precoding, link adaptation, or both, may be based on (e.g., rely on) SRS transmission. However, in some cases, such as for cell-edge UEs 115, channel estimation accuracy of SRS may not be reliable enough (e.g., may be associated with a reliability less than a threshold) for the network entity 105-a to derive accurate precoding information (e.g., a precoding for one or more antenna ports used to transmit one or more PUSCHSs 225) due to a lack of transmit (Tx) power of the UE 115-a (e.g., based on the UE 115-a being a cell-edge UE 115), due to a wideband property of the SRS, or both. In some cases, the wideband property of the SRS may not be adjusted to a narrowband property (e.g., narrowband SRS instead of wideband SRS) to increase the channel estimation accuracy of the SRS due to narrowband SRS being subject to a long latency for hopping to sweep an entire bandwidth. A cell-edge UE 115 may be a UE 115 with a proximity to the network entity 105-a that exceeds a threshold proximity (e.g., a cell-edge UE 115 is at least a threshold distance from the network entity 105-a).

Accordingly, techniques described herein may support an SRS-free uplink transmission procedure in which channel information, such as an uplink channel matrix, H, determined by the UE 115-a and noise-plus-interference information, such as an noise-plus-interference covariance matrix, Run, determined by the network entity 105-a may be used cooperatively (e.g., by the UE 115-a, the network entity 105-a, or both) to determine uplink precoding information, an MCS, or both, for one or more uplink transmissions (e.g., PUSCH transmissions) to be performed by the UE 115-a (e.g., without using one or more SRSs). For example, if a communication link between the UE 115-a and the network entity 105-a is associated with channel reciprocity (e.g., if uplink/downlink channel reciprocity holds, for a TDD carrier), the UE 115-a may acquire (e.g., derive, generate, calculate) an uplink channel matrix, H, representative of an uplink channel based on one or more CSI-RSs 210 received via a downlink channel (e.g., having channel reciprocity with the uplink channel), where the uplink channel matrix is associated with a higher reliability than SRS due to the network entity 105-a being capable of a TX power greater than a Tx power of the UE 115-a. Additionally, the network entity 105-a may acquire uplink interference and noise information, such as via generation of the noise-plus-interference covariance matrix, Rₙₙ, for example, based on one or more reference signal strength indicator (RSSI) measurements of one or more uplink signals 205. Thus, the UE 115-a, the network entity 105-a, or both, may use the uplink channel matrix, H, (e.g., channel information based on the one or more CSI-RSs 210) and the noise-plus-interference covariance matrix, Rₙₙ, cooperatively for uplink precoding, MCS determination, or both, without SRS transmission, which may result in improved link adaptation accuracy, improved precoding adaptation accuracy, reduced overhead (e.g., of SRS transmission), or any combination thereof.

For example, the UE 115-a may transmit one or more uplink signals 205 to the network entity 105-a, such that the network entity 105-a may perform one or more interference measurements, one or more noise measurements, or both, (e.g., RSSI measurements) based on the one or more uplink signals 205 to generate the noise-plus-interference covariance matrix, Rₙₙ. Additionally, the network entity 105-a may transmit, to the UE 115-a via the downlink channel, one or more CSI-RSs 210, such that the UE 115-a may generate (e.g., calculate, determine) the uplink channel matrix, H, for the uplink channel (e.g., that has channel reciprocity with the downlink channel) based on measurement of the one or more CSI-RSs 210.

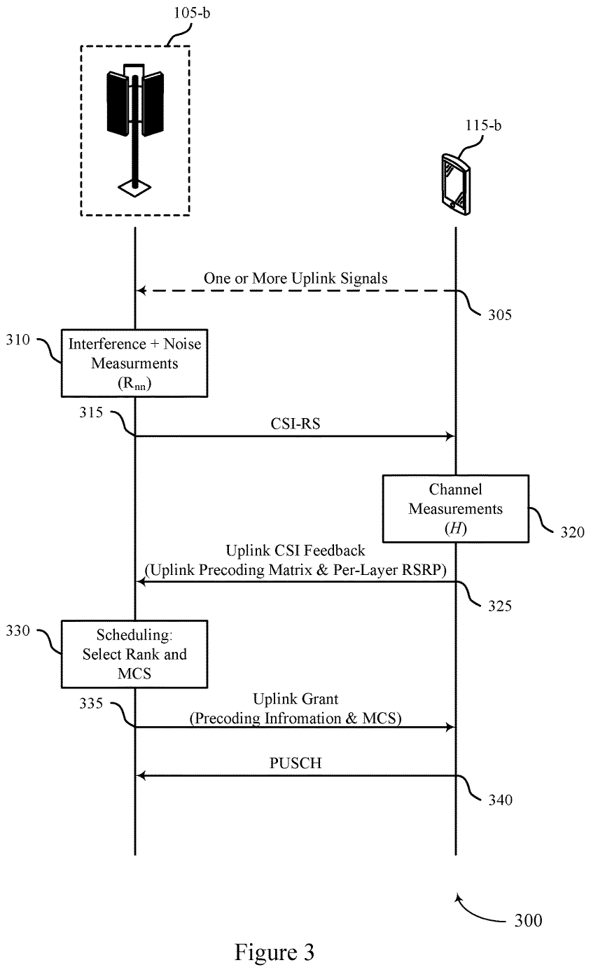

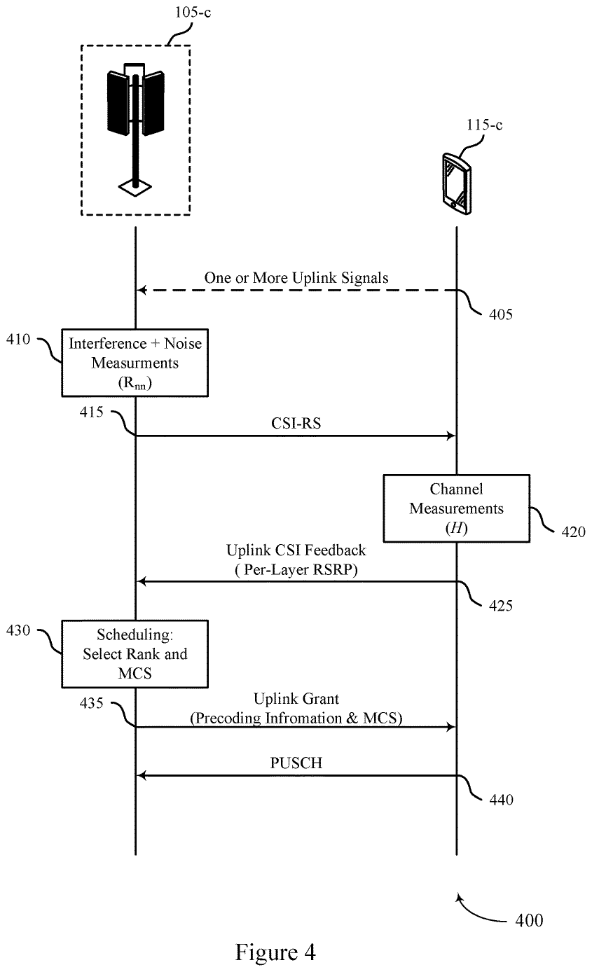

In some cases, as described with reference to FIGS. 3 and 4, the UE 115-a may additionally calculate an uplink precoding matrix, W_{UL}, and, based on the uplink precoding matrix, an RSRP for each layer, l, of multiple layers configured for the UE 115-a (e.g., l=1, . . . , R, where R is a total quantity of layers), which may be referred to as per-layer RSRPs,

$${γ}_{l}^{2} .$$

In some examples, as described with reference to FIG. 3, the UE 115-a may transmit, via uplink CSI feedback 215, an indication of the uplink precoding matrix and an indication of the per-layer RSRPs. In such cases, the network entity 105-a may determine uplink precoding information, an MCS, or both, for one or more PUSCHs 225 to be transmitted by the UE 115-a based on the uplink precoding matrix and the per-layer RSRPs. Thus, the network entity 105-a may transmit, to the UE 115-a via an uplink grant 220, an indication of the uplink precoding information, the MCS, or both. Alternatively, as described with reference to FIG. 4, the UE 115-a may transmit, via the uplink CSI feedback 215, the indication of the per-layer RSRPs, where the uplink precoding matrix is absent from the uplink CSI feedback 215. In such cases, the network entity 105-a may determine the uplink precoding information, the MCS, or both, based on the per-layer RSRPs, and may transmit, to the UE 115-a via the uplink grant 220, an indication of the uplink precoding information, the MCS, or both.

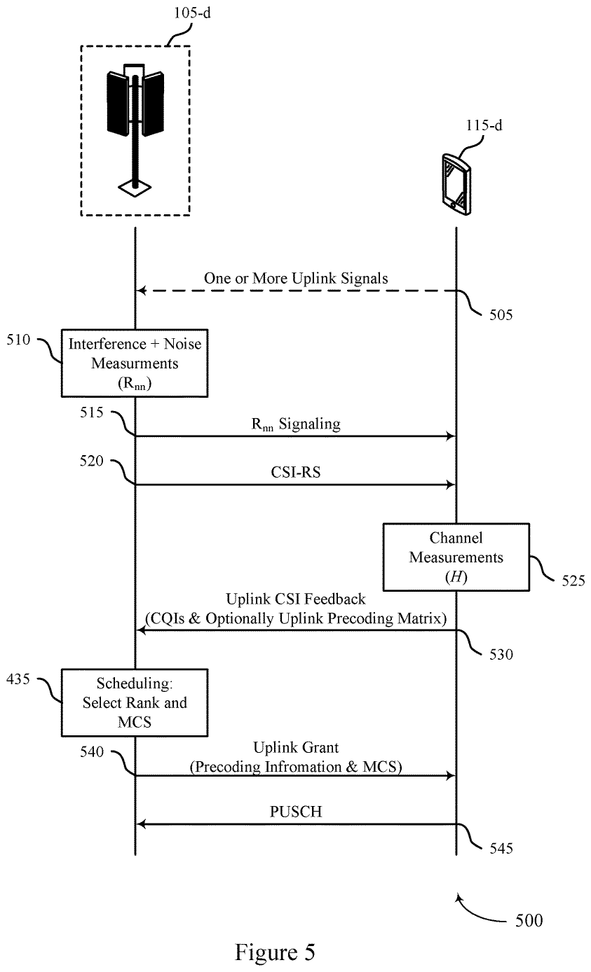

Additionally, or alternatively, as described with reference to FIG. 5, the network entity 105-a may transmit, to the UE 115-a, an indication of the noise-plus-interference covariance matrix, Rₙₙ. In such cases, the UE 115-a may calculate one or more CQIs based on the noise-plus-interference covariance matrix and the uplink channel matrix, and may transmit, via the uplink CSI feedback 215, an indication of the one or more CQIs. In some cases, the uplink CSI feedback 215 indicating the one or more CQIs may also indicate the uplink precoding matrix calculated by the UE 115-a. Thus, the network entity 105-a may determine the uplink precoding information, the MCS, or both, based on the one or more CQIs (e.g., and optionally the uplink precoding matrix), and may transmit, to the UE 115-a via the uplink grant 220, an indication of the uplink precoding information, the MCS, or both. Thus, the UE 115-a may transmit the one or more PUSCHs 225 scheduled by the uplink grant 220 in accordance with the uplink precoding information, the MCS, or both, indicated by the network entity 105-a.

In some cases, the UE 115-a may support the SRS-free uplink transmission procedure in addition to the first SRS-based uplink transmission procedure, the second SRS-based uplink transmission procedure, or both. In such cases, the UE 115-a may receive a first control message (e.g., RRC message, DCI message, or medium access control-control element (MAC-CE) message) indicating first configuration information for the SRS-free uplink transmission procedure and optionally second configuration information for the first SRS-based uplink transmission procedure, the second SRS-based uplink transmission procedure, or both. In some cases, the UE 115-a may perform the SRS-free uplink transmission procedure based on receiving the first configuration information. In some other cases, the UE 115-a may perform the SRS-free uplink transmission procedure based on receiving, from the network entity 105-a, a second control message (e.g., RRC message, DCI message, or MAC-CE message) indicating that the UE 115-a is to perform the SRS-free uplink transmission procedure. In some cases, the network entity 105-a may transmit the second control message based on determining that the UE 115-a is a cell-edge UE 115 (e.g., based on determining that a proximity of the UE 115-a to the network entity 105-a exceeds a threshold).

In some examples, the UE 115-a may transmit, to the network entity 105-a, capability information indicating that the UE 115-a supports the SRS-free uplink transmission procedure, the first SRS-based uplink transmission procedure, the second SRS-based uplink transmission procedure, or any combination thereof, such that the UE 115-a performing the SRS-free uplink transmission procedure may be based on transmission of the capability information. In other examples, the UE 115-a may transmit (e.g., provide), to the network entity 105-a, capability information indicating that the UE 115-a supports the reciprocity between the uplink channel and the downlink channel, and the network entity 105-a may determine (e.g., assume) that the UE 115-a supports the SRS-free uplink transmission procedure based on the capability information (e.g., based on the UE 115-a supporting the reciprocity). Thus, the network entity 105-a may configure the UE 115-a for the SRS-free uplink transmission procedure based on the capability information. Additionally, or alternatively, the UE 115-a may perform the SRS-free uplink transmission procedure based on the UE being a cell-edge UE 115.

In some cases, for the network entity 105-a to support multi-beam operations, multi-TRP operations, or both, the network entity 105-a may configure the UE 115-a with multiple CSI-RS resources which may be transmitted, by the network entity 105-a, for different beams 230 or different TRPs. For example, as depicted in FIG. 2A, the network entity 105-a may configure a first CSI-RS resource for transmission of a CSI-RS 210-a via a beam 230-a and a second CSI-RS resource for transmission of a CSI-RS 210-b via a beam 230-b. In another example (e.g., not depicted), rather than the network entity 105-a transmitting the CSI-RSs 210 via the multiple beams 230, the network entity 105-a may transmit the CSI-RS 210-a via the beam 230-a and another network entity 105 may transmit the CSI-RS 210-b via the beam 230-b. In either example, when the UE 115-a is configured with the multiple CSI-RS resources (e.g., the first CSI-RS resource and the second CIS-RS resource) and is configured to perform the SRS-free uplink transmission procedure (e.g., configured with corresponding CSI report settings to support the SRS-free uplink transmission procedure), the network entity 105-a may transmit, to the UE 115-a, an indication of which CSI-RS resource is associated with a scheduled PUSCH 225. For example, the network entity 105-a may transmit a control message indicating a CSI-RS index (CRI) (e.g., CRI information) associated with one of the first CSI-RS resource or the second CSI-RS resource. Thus, the UE 115-a may generate an uplink channel matrix based on reception of a CSI-RS 210 via the indicated CSI-RS resource.

Though described in the context of cell-edge UEs 115, this is not to be regarded as a limitation of the present disclosure. In this regard, any wireless device, including any type of UE 115, may support the techniques described herein.

FIG. 3 shows an example of a process flow 300 that supports SRS-free uplink transmission procedures. In some cases, the process flow 300 may implement or be implemented by aspects of the wireless communications system 100, the signaling diagram 200, or both. For example, the process flow 300 may include one or more UEs 115 (e.g., a UE 115-b) and one or more network entities 105 (e.g., a network entity 105-b), which may be examples of the corresponding devices as described herein. In the following description of the process flow 300, the operations between the UE 115-b and the network entity 105-b may be communicated in a different order than the example order shown, or the operations performed by the UE 115-b and the network entity 105-b may be performed in different orders or at different times. Some operations may also be omitted from the process flow 300, and other operations may be added to the process flow 300.

In some cases, as described with reference to FIG. 2A, a UE 115, such as the UE 115-b may report uplink CSI feedback indicating an uplink precoding matrix (e.g., first uplink precoding information) and one or more per-layer RSRPs for use by a network entity 105, such as the network entity 105-b, to determine second uplink precoding information, one or more MCSs, or both, for one or more PUSCHs to be transmitted by the UE 115-b.

For example, at 305, the UE 115-b may transmit one or more uplink signals (e.g., any uplink transmission) such that the network entity 105-b may generate, at 310, a noise-plus-interference covariance matrix, Rₙₙ, (e.g., interference and noise information) based on measurement of the one or more uplink signals. Additionally, at 315, the network entity 105-b may transmit (e.g., output), to the UE 115-b via a downlink channel, one or more CSI-RSs, such that, at 320, the UE 115-b may derive (e.g., calculate, generate, determine) an uplink channel matrix, H, for an uplink channel (e.g., that has channel reciprocity with the downlink channel) based on measurement of the one or more CSI-RSs. The UE 115-b may calculate an uplink precoding matrix, W_{UL}, (e.g., optimal uplink precoding matrix) based on the uplink channel matrix, measurement of the one or more CSI-RSs, or both. In some cases, the uplink precoding matrix may be represented according to the following Equation 4:

W_{UL}=[wₗ, . . . ,w_{R}] (4)

where R may represent a quantity of layers and wₗ may represent a precoder for an l-th layer, where l=1, . . . , R. Additionally, the UE 115-b may calculate a per-layer RSRP,

$${γ}_{l}^{2} ,$$

for each layer of a quantity of layers, R, according to the following Equation 5:

$${γ}_{l}^{2} = {‖ {Hw}_{l} ‖}^{2} \qquad ( 5 )$$

where

$${γ}_{l}^{2}$$

of an l-th layer, where l=1, . . . , R.

Thus, at 325, the UE 115-b may report uplink CSI feedback including (e.g., indicating) the uplink precoding matrix, W_{UL} (e.g., or a compressed version of the uplink precoding matrix), and the per-layer RSRP,

$${γ}_{l}^{2} ,$$

for each layer of the quantity of layers, R. In some cases, the UE 115-b may report the uplink CSI feedback in a subband manner (e.g., a subband report) or a wideband manner (e.g., a wideband report). The wideband report may include the uplink CSI feedback over an entire bandwidth of a component carrier configured for the UE 115-b. Conversely, the subband report may include the uplink CSI feedback over one or more subbands of the component carrier bandwidth. Additionally, or alternatively, the quantity of layers, R, may be equal to a quantity of receive antennas of the network entity 105-b (e.g., Nᵣ), may be configured by the network entity 105-b (e.g., via RRC signaling), may be determined by the UE 115-b (e.g., and reported with the uplink CSI feedback), or any combination thereof.

Thus, at 330, the network entity 105-b may use the uplink CSI feedback reported by the UE 115-b (e.g., the uplink precoding matrix and the per-layer RSRPs) and the noise-plus-interference covariance matrix, Rₙₙ, to determine a final (e.g., selected) precoding matrix, an MCS, or both, for one or more PUSCH transmissions to be performed by the UE 115-b. Consistent with Equation 5,

$${γ}_{l}^{2} / {ρ}_{nn}^{2}$$

may be equivalent to

$${σ}_{l}^{2}$$

(e.g., a singular value), where

$${ρ}_{nn}^{2}$$

may be a noise-plus-interference covariance derived from Rₙₙ.

Additionally, at 335, the network entity 105-b may transmit, to the UE 115-b, an uplink grant scheduling the one or more PUSCH transmissions and indicating the final precoding matrix (e.g., rank or column selection information from the uplink precoding matrix), the corresponding MCS, or both. In some cases, the network entity 105-b may indicate the final precoding matrix via an indication of a rank, R*, such that the UE 115-b may use the first R* columns of W_{UL} for PUSCH precoding

$$( e . g . , {W}_{UL}^{*} = [ {w}_{l} , … , {w}_{{R}^{*}} ] ( {R}^{*} < R ) ) .$$

In some other cases, the network entity 105-b may indicate the final precoding matrix via an indication of a column selection, where the column selection indicates one or more selected columns of W_{UL} for PUSCH precoding with

$${\sum }_{i = 1}^{R} ( \begin{matrix}R \\ i\end{matrix} )$$

states.

Thus, at 340, the UE 115-b may transmit, and the network entity 105-b may receive (e.g., obtain), the one or more PUSCHs in accordance with the uplink grant, the final precoding matrix, the corresponding MCS, or any combination thereof.

FIG. 4 shows an example of a process flow 400 that supports SRS-free uplink transmission procedures. In some cases, the process flow 400 may implement or be implemented by aspects of the wireless communications system 100, the signaling diagram 200, the process flow 300, or any combination thereof. For example, the process flow 400 may include one or more UEs 115 (e.g., a UE 115-c) and one or more network entities 105 (e.g., a network entity 105-c), which may be examples of the corresponding devices as described herein. In the following description of the process flow 400, the operations between the UE 115-c and the network entity 105-c may be communicated in a different order than the example order shown, or the operations performed by the UE 115-c and the network entity 105-c may be performed in different orders or at different times. Some operations may also be omitted from the process flow 400, and other operations may be added to the process flow 400.

In some cases, as described with reference to FIG. 3, a UE 115 may report uplink CSI feedback indicating an uplink precoding matrix (e.g., first uplink precoding information) and one or more per-layer RSRPs for use by a network entity 105 to determine second uplink precoding information, one or more MCSs, or both, for one or more PUSCHs to be transmitted by the UE 115. However, if a UE 115, such as the UE 115-c, is configured for single-user MIMO (SU-MIMO), rather than multiple-user MIMO (MU-MIMO), a network entity 105, such as the network entity 105-c, may be capable of determining the second uplink precoding information, the one or more MCSs, or both, without knowledge of the uplink precoding matrix (e.g., the exact uplink precoding matrix) derived by the UE 115-c. In such cases, the UE 115-c may apply UE-centric uplink precoding for PUSCH.

For example, at 405, the UE 115-c may transmit one or more uplink signals (e.g., any uplink transmission) such that the network entity 105-c may generate, at 410, a noise-plus-interference covariance matrix, Rₙₙ, (e.g., interference and noise information) based on measurement of the one or more uplink signals. Additionally, at 415, the network entity 105-c may transmit, to the UE 115-c via a downlink channel, one or more CSI-RSs, such that, at 420, the UE 115-c may derive (e.g., calculate, generate, determine) an uplink channel matrix, H, for an uplink channel (e.g., that has channel reciprocity with the downlink channel) based on measurement of the one or more CSI-RSs. In some cases, the UE 115-c may calculate a UE-centric uplink precoding matrix, W_{UL}, (e.g., optimal uplink precoding matrix) based on the uplink channel matrix, measurement of the one or more CSI-RSs, or both. In some cases, the uplink precoding matrix may be represented according to Equation 4, as described herein. Additionally, the UE 115-c may calculate a per-layer RSRP,

$${γ}_{l}^{2} ,$$

for each layer of a quantity of layers, R, according to Equation 5, as described herein.

Thus, at 425, the UE 115-c may report uplink CSI feedback including (e.g., indicating) the per-layer RSRP,

$${γ}_{l}^{2} ,$$

for each layer of the quantity of layers, R, and excluding the uplink precoding matrix, W_{UL} (e.g., or a compressed version of the uplink precoding matrix). In some cases, the UE 115-c may report the uplink CSI feedback in a subband manner (e.g., a subband report) or a wideband manner (e.g., a wideband report). Additionally, or alternatively, the quantity of layers, R, may be equal to a quantity of receive antennas of the network entity 105-c (e.g., Nᵣ), may be configured by the network entity 105-c (e.g., via RRC signaling), may be determined by the UE 115-c (e.g., and reported with the uplink CSI feedback), or any combination thereof.

Thus, at 430, the network entity 105-c may use the uplink CSI feedback reported by the UE 115-c (e.g., the per-layer RSRPs) and the noise-plus-interference covariance matrix, Run, to determine a final (e.g., selected) precoding matrix, an MCS, or both, for one or more PUSCH transmissions to be performed by the UE 115-c (e.g., for uplink scheduling).

Additionally, at 435, the network entity 105-c may transmit, to the UE 115-c, an uplink grant scheduling the one or more PUSCH transmissions and indicating the final precoding matrix (e.g., rank or column selection information from the uplink precoding matrix), the corresponding MCS, or both. In some cases, the network entity 105-c may indicate the final precoding matrix via an indication of a rank, R*, such that the UE 115-c may use the first R* columns of W_{UL} for PUSCH precoding

$$( e . g . , {W}_{UL}^{*} = [ {w}_{l} , … , {w}_{{R}^{*}} ] ( {R}^{*} < R ) ) .$$

In some other cases, the network entity 105-c may indicate the final precoding matrix via an indication of a column selection, where the column selection indications one or more selected columns of W_{UL} for PUSCH precoding with

$${\sum }_{i = 1}^{R} ( \begin{matrix}R \\ i\end{matrix} )$$

states.

Thus, at 440, the UE 115-c may transmit, the one or more PUSCHs in accordance with the uplink grant, the final precoding matrix, the corresponding MCS, or any combination thereof. For example, the UE 115-c may transmit the one or more PUSCHs in accordance with application of the selected column (e.g., or columns) of the UE-centric uplink precoding matrix (e.g., according to the uplink grant).

FIG. 5 shows an example of a process flow 500 that supports SRS-free uplink transmission procedures. In some cases, the process flow 500 may implement or be implemented by aspects of the wireless communications system 100, the signaling diagram 200, the process flow 300, the process flow 400, or any combination thereof. For example, the process flow 500 may include one or more UEs 115 (e.g., a UE 115-d) and one or more network entities 105 (e.g., a network entity 105-d), which may be examples of the corresponding devices as described herein. In the following description of the process flow 500, the operations between the UE 115-d and the network entity 105-d may be communicated in a different order than the example order shown, or the operations performed by the UE 115-d and the network entity 105-d may be performed in different orders or at different times. Some operations may also be omitted from the process flow 500, and other operations may be added to the process flow 500.

In some cases, as described with reference to FIG. 2A, a UE 115, such as the UE 115-d may report uplink CSI feedback indicating one or more CQIs for use by a network entity 105, such as the network entity 105-d, to determine uplink precoding information, one or more MCSs, or both, for one or more PUSCHs to be transmitted by the UE 115-d.

For example, at 505, the UE 115-d may transmit, to the network entity 105-d, one or more uplink signals (e.g., any uplink transmission) such that the network entity 105-d may generate, at 510, a noise-plus-interference covariance matrix, Rₙₙ, (e.g., interference and noise information, interference covariance matrix) based on measurement of the one or more uplink signals. At 515, the network entity 105-d may transmit, to the UE 115-d (e.g., via RRC signaling, via MAC-CE signaling), an indication of the noise-plus-interference covariance matrix, Rₙₙ.

Additionally, at 520, the network entity 105-d may transmit (e.g., output), to the UE 115-d via a downlink channel, one or more CSI-RSs, such that, at 525, the UE 115-d may derive (e.g., calculate, generate, determine) an uplink channel matrix, H, for an uplink channel (e.g., that has channel reciprocity with the downlink channel) based on measurement of the one or more CSI-RSs. In some cases, the UE 115-d may calculate an uplink precoding matrix, W_{UL}, (e.g., optimal uplink precoding matrix) based on the uplink channel matrix, measurement of the one or more CSI-RSs, or both. In some cases, the uplink precoding matrix may be represented according to Equation 4, as described herein.

Additionally, the UE 115-d may calculate one or more CQIs based on the uplink channel matrix, H, and the noise-plus-interference covariance matrix, Rₙₙ. In some cases, the one or more CQIs (e.g., CQI values) may include multiple CQIs, where each CQI of the multiple CQIs is calculated or a different rank assumption (e.g., of multiple rank assumptions).

Thus, at 530, the UE 115-d may report uplink CSI feedback including (e.g., indicating) the one or more CQIs and, optionally, the uplink precoding matrix (e.g., the uplink precoding matrix is omitted when UE-centric precoding is applied). In some cases, the UE 115-d may report the uplink CSI feedback in a subband manner (e.g., a subband report) or a wideband manner (e.g., a wideband report).

Thus, at 535, the network entity 105-d may use the uplink CSI feedback reported by the UE 115-d (e.g., the one or more CQIs) to determine a final (e.g., selected) precoding matrix, an MCS, or both, for one or more PUSCH transmissions to be performed by the UE 115-d.

Additionally, at 540, the network entity 105-d may transmit, to the UE 115-d, an uplink grant scheduling the one or more PUSCH transmissions and indicating the final precoding matrix (e.g., rank or column selection information from the uplink precoding matrix), the corresponding MCS, or both. In some cases, the network entity 105-d may indicate the final precoding matrix via an indication of a rank, R*, such that the UE 115-d may use the first R* columns of W_{UL} for PUSCH precoding

$$( e . g . , {W}_{UL}^{*} = [ {w}_{l} , … , {w}_{{R}^{*}} ] ( {R}^{*} < R ) ) .$$

In some other cases, the network entity 105-d may indicate the final precoding matrix via an indication of a column selection, where the column selection indications one or more selected columns of W_{UL} for PUSCH precoding with

$${\sum }_{i = 1}^{R} ( \begin{matrix}R \\ i\end{matrix} )$$

states.

Thus, at 545, the UE 115-d may transmit, and the network entity 105-d may receive (e.g., obtain), the one or more PUSCHs in accordance with the uplink grant, the final precoding matrix, the corresponding MCS, or any combination thereof.

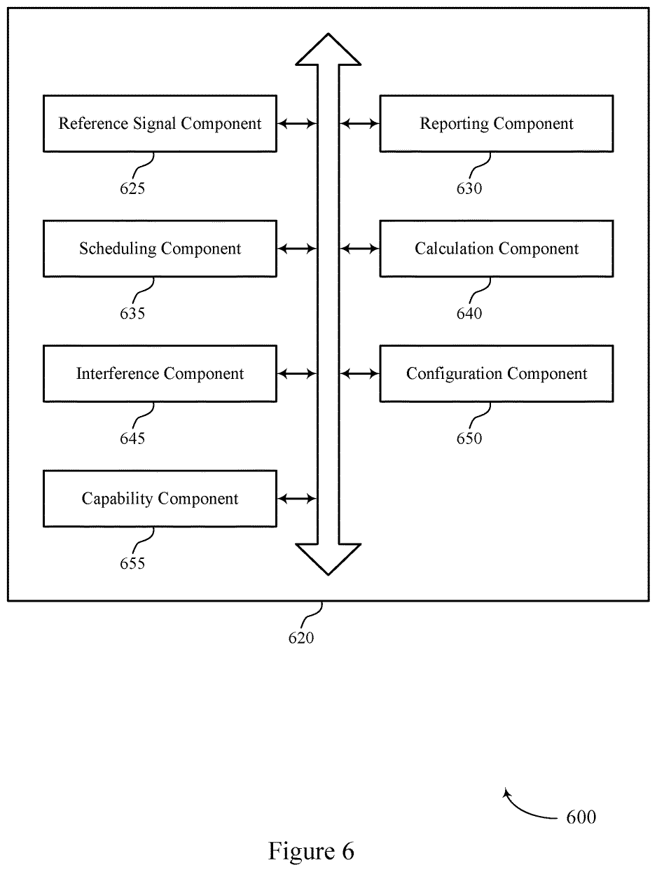

FIG. 6 shows an example 600 of a processing system 620 that supports SRS-free uplink transmission procedures. A processing system 620 may be an example of a processing system 140 (such as of a UE 115) and may include a reference signal component 625, a reporting component 630, a scheduling component 635, a calculation component 640, an interference component 645, a configuration component 650, a capability component 655, or any combination thereof. A processing system 620, or various component thereof, may be an example of means for performing (such as a means for causing a UE 115 to perform) various techniques described herein.

The reference signal component 625 may be configured to cause the UE 115 to receive, over a downlink channel, one or more CSI-RSs. The reporting component 630 may be configured to cause the UE 115 to transmit, in response to reception of the one or more CSI-RSs, CSI feedback for an uplink channel having channel reciprocity with the downlink channel, where the CSI feedback is generated based on an uplink channel matrix derived from measurement of the one or more CSI-RSs. The scheduling component 635 may be configured to cause the UE 115 to receive an uplink grant for the uplink channel that indicates uplink precoding information and one or more MCSs to be used by the UE for one or more uplink transmissions, where the uplink precoding information and one or more MCSs are in accordance with the CSI feedback.

In some examples, the calculation component 640 may be configured to cause the UE 115 to calculate an uplink precoding matrix based on the uplink channel matrix. In some examples, the calculation component 640 may be configured to cause the UE 115 to calculate a per-layer RSRP for each layer of a set of multiple layers, the CSI feedback further including an indication of a set of multiple per-layer RSRPs for the set of multiple layers.

In some examples, the CSI feedback further includes an indication of the uplink precoding matrix.

In some examples, the CSI feedback includes the uplink precoding matrix based on the UE operating in accordance with a MU-MIMO mode.

In some examples, the reporting component 630 may be configured to cause the UE 115 to transmit an indication of a quantity of the set of multiple layers for which the UE reported the per-layer RSRP.

In some examples, the configuration component 650 may be configured to cause the UE 115 to receive a control message indicative of a quantity of the set of multiple layers for which the UE is to report the per-layer RSRP.

In some examples, a quantity of the set of multiple layers is equal to a quantity of receive antennas at a network entity. In some examples, the one or more CSI-RSs are received from the network entity.

In some examples, the interference component 645 may be configured to cause the UE 115 to receive an indication of an interference covariance matrix, where the interference covariance matrix is based on one or more uplink signals transmitted by the UE. In some examples, the calculation component 640 may be configured to cause the UE 115 to calculate one or more CQIs in accordance with the uplink channel matrix and the interference covariance matrix, the CSI feedback further including an indication of the one or more CQIs.

In some examples, the one or more CQIs include a set of multiple CQIs. In some examples, each CQI of the set of multiple CQIs is based on a rank assumption from a set of multiple rank assumptions.

In some examples, the calculation component 640 may be configured to cause the UE 115 to calculate an uplink precoding matrix based on the uplink channel matrix, the CSI feedback further including an indication of the uplink precoding matrix.

In some examples, the CSI feedback is transmitted via a subband report or a wideband report.

In some examples, the uplink precoding information indicates a rank, a column of an uplink precoding matrix, or both, the one or more MCSs that are indicated via the uplink grant corresponding to the rank, the column, or both.

In some examples, the configuration component 650 may be configured to cause the UE 115 to receive first configuration information indicative of a set of multiple CSI-RS resources, where each CSI-RS resource of the set of multiple CSI-RS resources corresponds to a different beam, a different transmission reception point, or both. In some examples, the configuration component 650 may be configured to cause the UE 115 to receive second control information indicative of one or more CSI-RS resources from the set of multiple CSI-RS resources, where each CSI-RS of the one or more CSI-RSs is received via a corresponding CSI-RS resource of the one or more CSI-RS resources.

In some examples, the CSI feedback is obtained for the uplink channel in accordance with an SRS-free uplink transmission procedure, and the configuration component 650 may be configured to cause the UE 115 to receive a control message that indicates the UE is to perform the SRS-free uplink transmission procedure, where reception of the one or more CSI-RSs is in response to reception of the control message.

In some examples, the configuration component 650 may be configured to cause the UE 115 to receive configuration information for a set of multiple uplink transmission procedures, the set of multiple uplink transmission procedures including the SRS-free uplink transmission procedure and an SRS-based uplink transmission procedure, where reception of the control message is in accordance with the configuration information.

In some examples, the capability component 655 may be configured to cause the UE 115 to transmit capability information that indicates the UE supports the SRS-free uplink transmission procedure, where reception of the control message is in accordance with the capability information.

In some examples, reception of the control message that indicates the UE is to perform the SRS-free uplink transmission procedure is based on the UE being beyond a threshold proximity to a network entity. In some examples, the one or more CSI-RSs are received from the network entity.

In some examples, the SRS-free transmission procedure may include the uplink precoding information and the one or more MCSs being determined in an absence of one or more SRS.

In some examples, the scheduling component 635 may be configured to cause the UE 115 to transmit the one or more uplink transmissions in accordance with the uplink precoding information and the one or more MCSs.

A processing system 620 may include or be a component of one or more chips, systems-on-chips (SoCs), chipsets, packages, components, or devices that individually or collectively constitute or include a processing system. A processing system 620 may interface with other components of a processing system 620. For example, operations described with reference to a processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a processing system 620).

By including or configuring a processing system 620 for operation in a processing system 620 as described herein, the processing system 620 may support techniques for SRS-free uplink transmission procedures, which may result in improved communication reliability, reduced latency, improved user experience related to reduced processing, reduced power consumption, more efficient utilization of communication resources, improved coordination between devices, longer battery life, and improved utilization of processing capability, among other advantages.

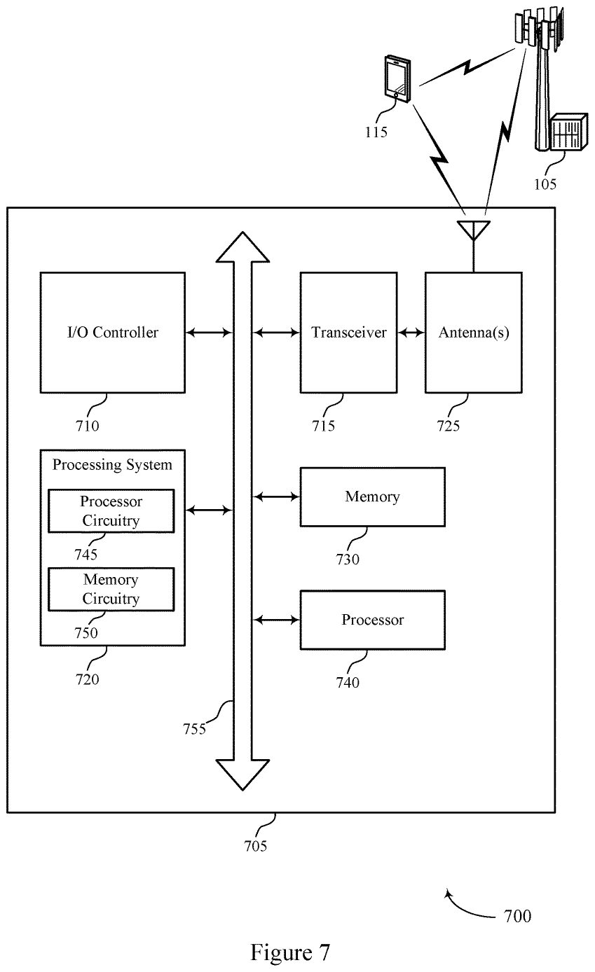

FIG. 7 shows an example of a system 700 including a device 705 that supports SRS-free uplink transmission procedures. The device 705 may be an example of or include components of UE 115. The device 705 may communicate (such as wirelessly) with one or more other devices (such as network entities 105, UEs 115). The device 705 may include components for transmitting and receiving communication, which may include a processing system 720, an input/output (I/O) controller, such as an I/O controller 710, a transceiver 715, antenna(s) 725, a memory 730, and a processor 740. Components of the device 705 may be coupled (such as operatively, communicatively, functionally, electronically, electrically, in electronic communication) a bus 755.

The transceiver 715 may support bi-directional communication via antenna(s) 725, and may support transmission operations, reception operations, or both, as described herein. The transceiver 715 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 705). The transceiver 715 may modulate symbols and provide the modulated symbols to antenna(s) 725 for transmission, and demodulate symbols from signals received using antenna(s) 725.

The processor 740 may be a general-purpose processing component that supports various operations (such as applications) of the device 705. The memory 730 may be a general-purpose storage component that stores code executable by the processor 740. Such code may include instructions that, when executed by the processor 740, cause the device 705 to perform various functions (such as to support an application of the device 705). The I/O controller 710 may manage inputs and outputs for the device 705, may manage peripherals not integrated into the device 705, or may represent a physical connection (such as port) to an external peripheral. The processor 740 may interact with a modem, a keyboard, a mouse, a touchscreen, or other device (such as via I/O controller 710). In some implementations, a user may interact with the device 705 via the I/O controller 710 or via hardware components controlled by the I/O controller 710.

The processing system 720 may be an example of a processing system 140 or a processing system 620. For example, the processing system 720 may include processor circuitry 745 and memory circuitry 750 that stores code, and may be configured to cause the device 705 to perform operations that support SRS-free uplink transmission procedures. Although the processing system 720 is illustrated as a separate component, which may involve a separate chip, chipset, or other module, in some implementations, one or more functions described with reference to the processing system 720 may be supported by or performed by a transceiver 715, antenna(s) 725, a processor 740, memory 730, or any combination thereof, such that a processing system 720 may include one or more of a transceiver 715, antenna(s) 725, a processor 740, memory 730, or any combination thereof.

By including or configuring the processing system 720 for operation in the device 705 as described herein, may support techniques for SRS-free uplink transmission procedures, which may result in improved communication reliability, reduced latency, improved user experience related to reduced processing, reduced power consumption, more efficient utilization of communication resources, improved coordination between devices, longer battery life, and improved utilization of processing capability, among other advantages.

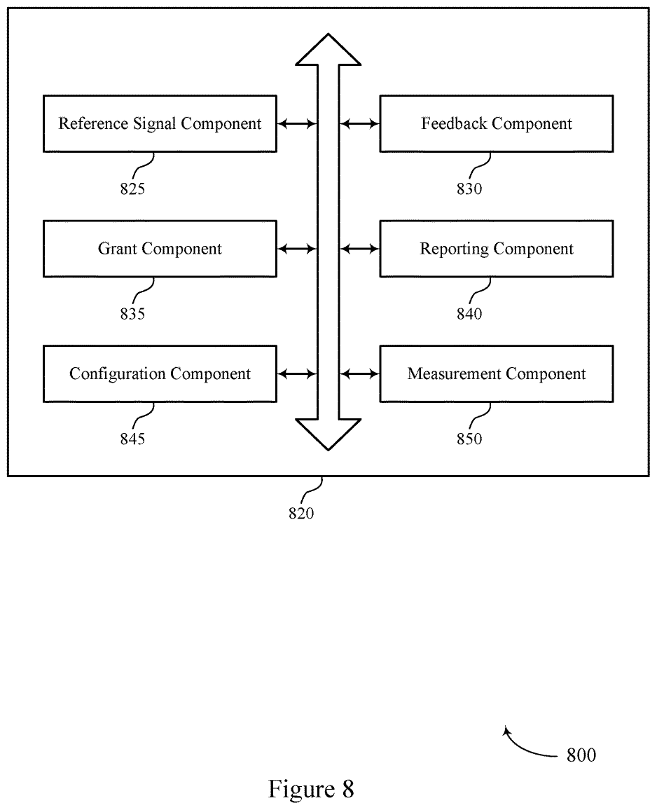

FIG. 8 shows an example 800 of a processing system 820 that supports SRS-free uplink transmission procedures. A processing system 820 may be an example of a processing system 145 (such as network entity 105) and may include a reference signal component 825, a feedback component 830, a grant component 835, a reporting component 840, a configuration component 845, a measurement component 850, or any combination thereof. A processing system 820, or various component thereof, may be an example of means for performing (such as a means for causing a network entity 105 to perform) various techniques described herein.

The reference signal component 825 may be configured to cause the network entity 105 to output, over a downlink channel, one or more CSI-RSs. The feedback component 830 may be configured to cause the network entity 105 to obtain, in response to transmission of the one or more CSI-RSs, CSI feedback for an uplink channel having channel reciprocity with the downlink channel. The grant component 835 may be configured to cause the network entity 105 to output an uplink grant for the uplink channel that indicates uplink precoding information and one or more MCSs to be used by a UE for one or more uplink transmissions over the uplink channel, where the uplink precoding information and one or more MCSs are calculated in accordance with the CSI feedback.

In some examples, the CSI feedback includes an indication of a per-layer RSRP for each layer of a set of multiple layers.

In some examples, the CSI feedback further includes an indication of an uplink precoding matrix. In some examples, the uplink precoding matrix is based on an uplink channel matrix representative of the uplink channel.

In some examples, the CSI feedback includes the uplink precoding matrix based on the UE operating in accordance with a MU-MIMO mode.

In some examples, the feedback component 830 may be configured to cause the network entity 105 to obtain an indication of a quantity of the set of multiple layers for which the UE reported the per-layer RSRP.

In some examples, the configuration component 845 may be configured to cause the network entity 105 to transmit a control message indicative of a quantity of the set of multiple layers for which the UE is to report the per-layer RSRP.

In some examples, a quantity of the set of multiple layers is equal to a quantity of receive antennas at the network entity.

In some examples, the reporting component 840 may be configured to cause the network entity 105 to generate an interference covariance matrix, where the interference covariance matrix is generated in accordance with one or more uplink signals obtained from the UE. In some examples, the reporting component 840 may be configured to cause the network entity 105 to output an indication of the interference covariance matrix, where CSI feedback including an indication of one or more CQIs, and where the one or more CQIs are based on the interference covariance matrix.

In some examples, the one or more CQIs include a set of multiple CQIs. In some examples, each CQI of the set of multiple CQIs is based on a rank assumption from a set of multiple rank assumptions.

In some examples, the CSI feedback further includes an indication of an uplink precoding matrix. In some examples, the uplink precoding matrix is based on an uplink channel matrix representative of the uplink channel.

In some examples, the CSI feedback is obtained via a subband report or a wideband report.

In some examples, the uplink precoding information indicates a rank, a column of an uplink precoding matrix, or both, the one or more MCSs that are indicated via the uplink grant corresponding to the rank, the column, or both.

In some examples, the configuration component 845 may be configured to cause the network entity 105 to output first configuration information indicative of a set of multiple CSI-RS resources, where each CSI-RS resource of the set of multiple CSI-RS resources corresponds to a different beam, a different transmission reception point, or both. In some examples, the configuration component 845 may be configured to cause the network entity 105 to output second control information indicative of one or more CSI-RS resources from the set of multiple CSI-RS resources, where each CSI-RS of the one or more CSI-RSs is output via a corresponding CSI-RS resource of the one or more CSI-RS resources.

In some examples, the CSI feedback is obtained for the uplink channel in accordance with an SRS-free uplink transmission procedure, and the configuration component 845 may be configured to cause the network entity 105 to transmit a control message that indicates the UE is to perform the SRS-free uplink transmission procedure, where reception of the one or more CSI-RSs is in response to reception of the control message.

In some examples, the configuration component 845 may be configured to cause the network entity 105 to output configuration information for a set of multiple uplink transmission procedures, the set of multiple uplink transmission procedures including the SRS-free uplink transmission procedure and an SRS-based uplink transmission procedure, where output of the control message is in accordance with the configuration information.

In some examples, the feedback component 830 may be configured to cause the network entity 105 to obtain capability information that indicates the UE supports the SRS-free uplink transmission procedure, where output of the control message is in accordance with the capability information.

In some examples, output of the control message that indicates the UE is to perform the SRS-free uplink transmission procedure is based on the UE being beyond a threshold proximity to a network entity. In some examples, the one or more CSI-RSs are received from the network entity.

In some examples, the measurement component 850 may be configured to cause the network entity 105 to perform one or more measurements of the UE, where output of the control message is in accordance with the one or more measurements satisfying one or more thresholds.

In some examples, the one or more measurements include a proximity of the UE to the network entity. In some examples, output of the control message is in accordance with the proximity of the UE satisfying a threshold proximity of the one or more thresholds.

In some examples, the SRS-free transmission procedure may include the uplink precoding information and the one or more MCSs being determined in an absence of one or more SRS.

In some examples, the grant component 835 may be configured to cause the network entity 105 to obtain the one or more uplink transmissions in accordance with the uplink precoding information and the one or more MCSs.

A processing system 820 may include or be an example of one or more chips, SoCs, chipsets, packages, components, or devices that individually or collectively constitute or include a processing system. A processing system 820 may interface with other components of a network entity 105. For example, operations described with reference to a processing system 820, or various components thereof, may be performed by or with other such components, including a receiver, a transmitter, a transceiver, a modem, a user interface, a modulator/demodulator, an encoder/decoder, or any combination thereof (such as of the processing system 820, coupled with the processing system 820, of a network entity 105). Operations described herein with reference to the processing system 820, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 820 for operation in a processing system 820 as described herein, the processing system 820 may support techniques for SRS-free uplink transmission procedures, which may result in improved communication reliability, reduced latency, improved user experience related to reduced processing, reduced power consumption, more efficient utilization of communication resources, improved coordination between devices, longer battery life, and improved utilization of processing capability, among other advantages.

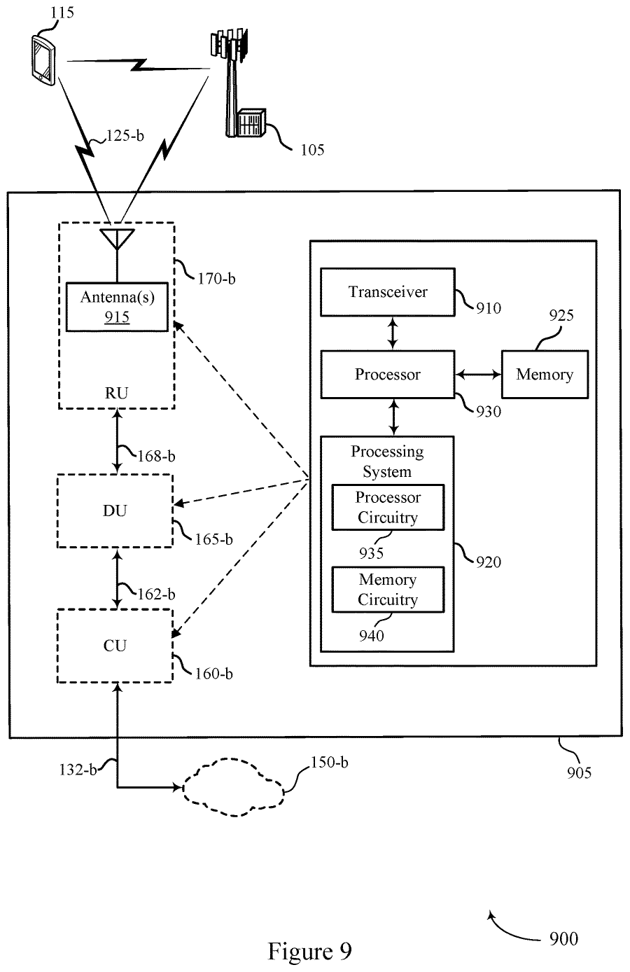

FIG. 9 shows an example of a system 900 including a device 905 that supports SRS-free uplink transmission procedures. The device 905 may communicate (such as via one or more wired interfaces or one or more wireless interfaces) with other network devices or network equipment such as a core network 150-b, other network entities 105, UEs 115, or any combination thereof. The device 905 may include components for transmitting and receiving communication, which may include a processing system 920, a transceiver 910, antenna(s) 915, a memory 925, and a processor 930. Components of the device 905 may be coupled (such as operatively, communicatively, functionally, electronically, electrically, in electronic communication) via one or more interfaces.

The transceiver 910 may communicate bi-directionally with another transceiver via wired or wireless links, and may support transmission operations, reception operations, or both, as described herein. The transceiver 910 may include a modem to modulate and demodulate signals, to provide the modulated signals for transmission (such as via antenna(s) 915, via a wired interface), and to demodulate received signals (such as received via antenna(s) 915, received via a wired interface). The transceiver 910 may be operable to support communication via one or more communication links (such as a communication link 125-b, a backhaul link 132-b, a midhaul link 162-b, fronthaul link 168-b).

The processor 930 may be a general-purpose processing component that supports various operations (such as applications) of the device 905. The memory 925 may be a general-purpose storage component that stores code executable by the processor 930. Such code may include instructions that, when executed by the processor 930, cause the device 905 to perform various functions (such as to support an application of the device 905).

For examples in which the device 905 is a network entity 105 in a disaggregated architecture, one or more components of the device 905 may be located at one or more of a CU 160-b, a DU 165-b, or an RU 170-b, one or more of which may include aspects of the processing system 920, the processor 930, the memory 925, or the transceiver 910. Functions of the device 905 may be performed at different components or an operation may be divided between different components (such as different functions being supported by aspects of the CU 160-b, the DU 165-b, or the RU 170-b, the transceiver 910, the processor 930, the memory 925, the processing system 920, or any combination thereof). For example, the processing system 920 may be a component of one or more of the CU 160-b, the DU 165-b, or the RU 170-b. In some examples, interfaces between components of device 905 (such as CU 160-b, DU 165-b, RU 170-b) may support communication at a protocol layer or between protocol layers of a protocol stack.

In some examples, the processing system 920 may manage aspects of communication with the core network 150-b (such as via a backhaul link 132). For example, the processing system 920 may manage the transfer of data communication for UEs 115 with a gateway of the core network 150-b. In some examples, the processing system 920 may manage communication with one or more other network entities 105 and may include a controller or scheduler for controlling communication with UEs 115 (such as in cooperation with the one or more other network entities 105). In some examples, the processing system 920 may support an interface (such as X2 interface, Xn interface) to provide communication between network entities 105.

The processing system 920 may be an example of a processing system 145 or a processing system 820. For example, the processing system 920 may include processor circuitry 935 and memory circuitry 940 that stores code, and the processing system 920 may be configured to cause the device 905 to perform operations that support SRS-free uplink transmission procedures. Although the processing system 920 is illustrated as a separate component, which may involve a separate chip, chipset, or other module, in some implementations, one or more functions described with reference to the processing system 920 may be supported by or performed by a transceiver 910, antenna(s) 915, a processor 930, memory 925, or any combination thereof, such that a processing system 920 may include one or more of a transceiver 910, antenna(s) 915, a processor 930, memory 925, or any combination thereof. Further, processor circuitry 935 and memory circuitry 940 each may be implemented at the device 905 in accordance with an aggregated architecture, or the processor circuitry 935 and the memory circuitry 940 may be implemented at one or more of a CU 160-b, a DU 165-b, or an RU 170-b in accordance with a disaggregated architecture.

By including or configuring the processing system 920 for operation in the device 905 as described herein, may support techniques for SRS-free uplink transmission procedures, which may result in improved communication reliability, reduced latency, improved user experience related to reduced processing, reduced power consumption, more efficient utilization of communication resources, improved coordination between devices, longer battery life, and improved utilization of processing capability, among other advantages.

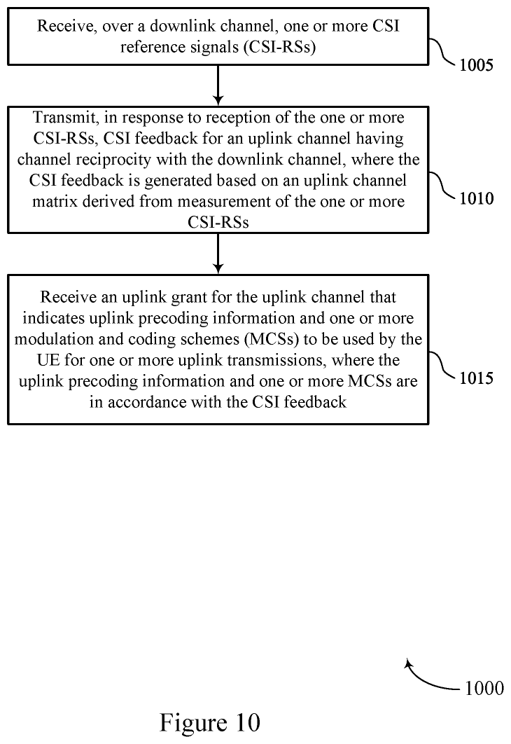

FIG. 10 shows an example of a method 1000 that supports SRS-free uplink transmission procedures. Operations of the method 1000 may be performed by a UE or its components (such as using a processing system configured to cause the UE 115 to perform one or more of the operations) as described herein.

At 1005, the method may include receiving, over a downlink channel, one or more CSI-RSs. In some examples, aspects of the operations of 1005 may be performed by a reference signal component 625.

At 1010, the method may include transmitting, in response to reception of the one or more CSI-RSs, CSI feedback for an uplink channel having channel reciprocity with the downlink channel, where the CSI feedback is generated based on an uplink channel matrix derived from measurement of the one or more CSI-RSs. In some examples, aspects of the operations of 1010 may be performed by a reporting component 630.

At 1015, the method may include receiving an uplink grant for the uplink channel that indicates uplink precoding information and one or more MCSs to be used by the UE for one or more uplink transmissions, where the uplink precoding information and one or more MCSs are in accordance with the CSI feedback. In some examples, aspects of the operations of 1015 may be performed by a scheduling component 635.

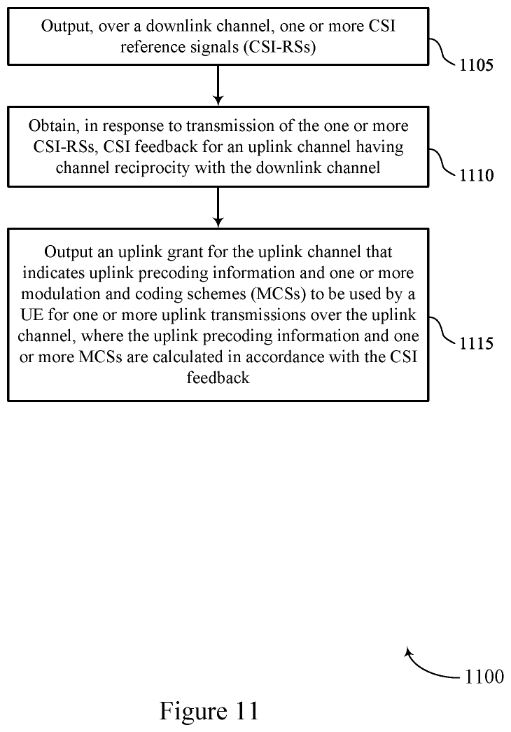

FIG. 11 shows an example of a method 1100 that supports SRS-free uplink transmission procedures. Operations of the method 1100 may be performed by a network entity 105 or its components (such as using a processing system configured to cause the network entity to perform one or more operations) as described herein.

At 1105, the method may include outputting, over a downlink channel, one or more CSI-RSs. In some examples, aspects of the operations of 1105 may be performed by a reference signal component 825.

At 1110, the method may include obtaining, in response to transmission of the one or more CSI-RSs, CSI feedback for an uplink channel having channel reciprocity with the downlink channel. In some examples, aspects of the operations of 1110 may be performed by a feedback component 830.

At 1115, the method may include outputting an uplink grant for the uplink channel that indicates uplink precoding information and one or more MCSs to be used by a UE for one or more uplink transmissions over the uplink channel, where the uplink precoding information and one or more MCSs are calculated in accordance with the CSI feedback. In some examples, aspects of the operations of 1115 may be performed by a grant component 835.

Implementation examples are described in the following numbered clauses:

Aspect 1: A method for wireless communications at a UE, comprising: receiving, over a downlink channel, one or more CSI-RSs; transmitting, in response to reception of the one or more CSI-RSs, CSI feedback for an uplink channel having channel reciprocity with the downlink channel, wherein the CSI feedback is generated based at least in part on an uplink channel matrix derived from measurement of the one or more CSI-RSs; and receiving an uplink grant for the uplink channel that indicates uplink precoding information and one or more MCSs to be used by the UE for one or more uplink transmissions, wherein the uplink precoding information and one or more MCSs are in accordance with the CSI feedback.

Aspect 2: The method of aspect 1, further comprising: calculating an uplink precoding matrix based at least in part on the uplink channel matrix; and calculating a per-layer RSRP for each layer of a plurality of layers, the CSI feedback further comprising an indication of a plurality of per-layer RSRPs for the plurality of layers.

Aspect 3: The method of aspect 2, wherein the CSI feedback further comprises an indication of the uplink precoding matrix.

Aspect 4: The method of aspect 3, wherein the CSI feedback comprises the uplink precoding matrix based at least in part on the UE operating in accordance with a MU-MIMO mode.

Aspect 5: The method of any of aspects 2 through 4, further comprising: transmitting an indication of a quantity of the plurality of layers for which the UE reported the per-layer RSRP.

Aspect 6: The method of any of aspects 2 through 5, further comprising: receiving a control message indicative of a quantity of the plurality of layers for which the UE is to report the per-layer RSRP.

Aspect 7: The method of any of aspects 2 through 6, wherein a quantity of the plurality of layers is equal to a quantity of receive antennas at a network entity, and the one or more CSI-RSs are received from the network entity.

Aspect 8: The method of any of aspects 1 through 7, further comprising: receiving an indication of an interference covariance matrix, wherein the interference covariance matrix is based at least in part on one or more uplink signals transmitted by the UE; and calculating one or more CQIs in accordance with the uplink channel matrix and the interference covariance matrix, the CSI feedback further comprising an indication of the one or more CQIs.

Aspect 9: The method of aspect 8, wherein the one or more CQIs comprise a plurality of CQIs, and each CQI of the plurality of CQIs is based at least in part on a rank assumption from a plurality of rank assumptions.

Aspect 10: The method of any of aspects 8 through 9, further comprising: calculating an uplink precoding matrix based at least in part on the uplink channel matrix, the CSI feedback further comprising an indication of the uplink precoding matrix.

Aspect 11: The method of any of aspects 1 through 10, wherein the CSI feedback is transmitted via a subband report or a wideband report.

Aspect 12: The method of any of aspects 1 through 11, wherein the uplink precoding information indicates a rank, a column of an uplink precoding matrix, or both, the one or more MCSs that are indicated via the uplink grant corresponding to the rank, the column, or both.

Aspect 13: The method of any of aspects 1 through 12, further comprising: receiving first configuration information indicative of a plurality of CSI-RS resources, wherein each CSI-RS resource of the plurality of CSI-RS resources corresponds to a different beam, a different transmission reception point, or both; and receiving second control information indicative of one or more CSI-RS resources from the plurality of CSI-RS resources, wherein each CSI-RS of the one or more CSI-RSs is received via a corresponding CSI-RS resource of the one or more CSI-RS resources.

Aspect 14: The method of any of aspects 1 through 13, wherein the CSI feedback is obtained for the uplink channel in accordance with an SRS-free uplink transmission procedure, and wherein the method further comprises: receiving a control message that indicates the UE is to perform the SRS-free uplink transmission procedure, wherein reception of the one or more CSI-RSs is in response to reception of the control message.

Aspect 15: The method of aspect 14, further comprising: receiving configuration information for a plurality of uplink transmission procedures, the plurality of uplink transmission procedures comprising the SRS-free uplink transmission procedure and an SRS-based uplink transmission procedure, wherein reception of the control message is in accordance with the configuration information.

Aspect 16: The method of any of aspects 14 through 15, further comprising: transmitting capability information that indicates the UE supports the SRS-free uplink transmission procedure, wherein reception of the control message is in accordance with the capability information.

Aspect 17: The method of any of aspects 14 through 16, wherein reception of the control message that indicates the UE is to perform the SRS-free uplink transmission procedure is based at least in part on the UE being beyond a threshold proximity to a network entity, and the one or more CSI-RSs are received from the network entity.

Aspect 18: The method of any of aspects 14 through 17, wherein the SRS-free transmission procedure comprises the uplink precoding information and the one or more MCSs being determined in an absence of one or more SRS.

Aspect 19: The method of any of aspects 1 through 17, further comprising: transmitting the one or more uplink transmissions in accordance with the uplink precoding information and the one or more MCSs.

Aspect 20: A method for wireless communications at a network entity, comprising: outputting, over a downlink channel, one or more CSI-RSs; obtaining, in response to transmission of the one or more CSI-RSs, CSI feedback for an uplink channel having channel reciprocity with the downlink channel; and outputting an uplink grant for the uplink channel that indicates uplink precoding information and one or more MCSs to be used by a UE for one or more uplink transmissions over the uplink channel, wherein the uplink precoding information and one or more MCSs are calculated in accordance with the CSI feedback.

Aspect 21: The method of aspect 20, wherein the CSI feedback comprises an indication of a per-layer RSRP for each layer of a plurality of layers.

Aspect 22: The method of aspect 21, wherein the CSI feedback further comprises an indication of an uplink precoding matrix, and the uplink precoding matrix is based at least in part on an uplink channel matrix representative of the uplink channel.

Aspect 23: The method of aspect 22, wherein the CSI feedback comprises the uplink precoding matrix based at least in part on the UE operating in accordance with a MU-MIMO mode.

Aspect 24: The method of any of aspects 21 through 23, further comprising: obtaining an indication of a quantity of the plurality of layers for which the UE reported the per-layer RSRP.

Aspect 25: The method of any of aspects 21 through 24, further comprising: transmitting a control message indicative of a quantity of the plurality of layers for which the UE is to report the per-layer RSRP.

Aspect 26: The method of any of aspects 21 through 25, wherein a quantity of the plurality of layers is equal to a quantity of receive antennas at the network entity.

Aspect 27: The method of any of aspects 20 through 26, further comprising: generating an interference covariance matrix, wherein the interference covariance matrix is generated in accordance with one or more uplink signals obtained from the UE, and outputting an indication of the interference covariance matrix, the CSI feedback further comprising an indication of one or more CQIs, and wherein the one or more CQIs are based at least in part on the interference covariance matrix.

Aspect 28: The method of aspect 27, wherein the one or more CQIs comprise a plurality of CQIs, and each CQI of the plurality of CQIs is based at least in part on a rank assumption from a plurality of rank assumptions.

Aspect 29: The method of any of aspects 27 through 28, wherein the CSI feedback further comprises an indication of an uplink precoding matrix, and the uplink precoding matrix is based at least in part on an uplink channel matrix representative of the uplink channel.

Aspect 30: The method of any of aspects 20 through 29, wherein the CSI feedback is obtained via a subband report or a wideband report.

Aspect 31: The method of any of aspects 20 through 30, wherein the uplink precoding information indicates a rank, a column of an uplink precoding matrix, or both, the one or more MCSs that are indicated via the uplink grant corresponding to the rank, the column, or both.

Aspect 32: The method of any of aspects 20 through 31, further comprising: outputting first configuration information indicative of a plurality of CSI-RS resources, wherein each CSI-RS resource of the plurality of CSI-RS resources corresponds to a different beam, a different transmission reception point, or both; and outputting second control information indicative of one or more CSI-RS resources from the plurality of CSI-RS resources, wherein each CSI-RS of the one or more CSI-RSs is output via a corresponding CSI-RS resource of the one or more CSI-RS resources.

Aspect 33: The method of any of aspects 20 through 32, wherein the CSI feedback is obtained for the uplink channel in accordance with an SRS-free uplink transmission procedure, and wherein the method further comprises: transmitting a control message that indicates the UE is to perform the SRS-free uplink transmission procedure, wherein reception of the one or more CSI-RSs is in response to reception of the control message.

Aspect 34: The method of aspect 33, further comprising: outputting configuration information for a plurality of uplink transmission procedures, the plurality of uplink transmission procedures comprising the SRS-free uplink transmission procedure and an SRS-based uplink transmission procedure, wherein output of the control message is in accordance with the configuration information.

Aspect 35: The method of any of aspects 33 through 34, further comprising: obtaining capability information that indicates the UE supports the SRS-free uplink transmission procedure, wherein output of the control message is in accordance with the capability information.

Aspect 36: The method of any of aspects 33 through 35, wherein output of the control message that indicates the UE is to perform the SRS-free uplink transmission procedure is based at least in part on the UE being beyond a threshold proximity to a network entity, and the one or more CSI-RSs are received from the network entity.

Aspect 37: The method of any of aspects 33 through 36, further comprising: performing one or more measurements of the UE, wherein output of the control message is in accordance with the one or more measurements satisfying one or more thresholds.

Aspect 38: The method of aspect 37, wherein the one or more measurements comprise a proximity of the UE to the network entity, and output of the control message is in accordance with the proximity of the UE satisfying a threshold proximity of the one or more thresholds.

Aspect 39: The method of any of aspects 33 through 38, wherein the SRS-free transmission procedure comprises the uplink precoding information and the one or more MCSs being determined in an absence of one or more SRS.

Aspect 40: The method of any of aspects 20 through 38, further comprising: obtaining the one or more uplink transmissions in accordance with the uplink precoding information and the one or more MCSs.

Aspect 41: A UE for wireless communications, comprising a processing system that includes processor circuitry and memory circuitry that stores code, the processing system configured to cause the UE to perform a method of any of aspects 1 through 19.

Aspect 42: A UE for wireless communications, comprising at least one means for performing a method of any of aspects 1 through 19.

Aspect 43: A non-transitory computer-readable medium storing code for wireless communications, the code comprising instructions executable by one or more processors to perform a method of any of aspects 1 through 19.

Aspect 44: A network entity for wireless communications, comprising a processing system that includes processor circuitry and memory circuitry that stores code, the processing system configured to cause the network entity to perform a method of any of aspects 20 through 40.

Aspect 45: A network entity for wireless communications, comprising at least one means for performing a method of any of aspects 20 through 40.

Aspect 46: A non-transitory computer-readable medium storing code for wireless communications, the code comprising instructions executable by one or more processors to perform a method of any of aspects 20 through 40.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, over a downlink channel, one or more channel state information (CSI) reference signals (CSI-RSs);
transmit, in response to reception of the one or more CSI-RSs, CSI feedback for an uplink channel having channel reciprocity with the downlink channel, wherein the CSI feedback is generated based at least in part on an uplink channel matrix derived from measurement of the one or more CSI-RSs; and
receive an uplink grant for the uplink channel that indicates uplink precoding information and one or more modulation and coding schemes (MCSs) to be used by the UE for one or more uplink transmissions, wherein the uplink precoding information and one or more MCSs are in accordance with the CSI feedback.

2. The UE of claim 1, wherein the one or more processors are individually or collectively further operable to execute the code to cause the UE to:
calculate an uplink precoding matrix based at least in part on the uplink channel matrix; and
calculate a per-layer reference signal receive power (RSRP) for each layer of a plurality of layers, the CSI feedback further comprising an indication of a plurality of per-layer RSRPs for the plurality of layers.

3. The UE of claim 2, wherein the CSI feedback further comprises an indication of the uplink precoding matrix.

4. The UE of claim 3, wherein the CSI feedback comprises the uplink precoding matrix based at least in part on the UE operating in accordance with a multi-user multiple input multiple output (MU-MIMO) mode.

5. The UE of claim 2, wherein the one or more processors are individually or collectively further operable to execute the code to cause the UE to:
transmit an indication of a quantity of the plurality of layers for which the UE reported the per-layer RSRP.

6. The UE of claim 2, wherein the one or more processors are individually or collectively further operable to execute the code to cause the UE to:
receive a control message indicative of a quantity of the plurality of layers for which the UE is to report the per-layer RSRP.

7. The UE of claim 2, wherein a quantity of the plurality of layers is equal to a quantity of receive antennas at a network entity, and wherein the one or more CSI-RSs are received from the network entity.

8. The UE of claim 1, wherein the one or more processors are individually or collectively further operable to execute the code to cause the UE to:
receive an indication of an interference covariance matrix, wherein the interference covariance matrix is based at least in part on one or more uplink signals transmitted by the UE; and
calculate one or more channel quality indicators (CQIs) in accordance with the uplink channel matrix and the interference covariance matrix, the CSI feedback further comprising an indication of the one or more CQIs.

9. The UE of claim 8, wherein the one or more CQIs comprise a plurality of CQIs, and wherein each CQI of the plurality of CQIs is based at least in part on a rank assumption from a plurality of rank assumptions.

10. The UE of claim 1, wherein the CSI feedback is transmitted via a subband report or a wideband report.

11. The UE of claim 1, wherein the uplink precoding information indicates a rank, a column of an uplink precoding matrix, or both, the one or more MCSs that are indicated via the uplink grant corresponding to the rank, the column, or both.

12. The UE of claim 1, wherein the one or more processors are individually or collectively further operable to execute the code to cause the UE to:
receive first configuration information indicative of a plurality of CSI-RS resources, wherein each CSI-RS resource of the plurality of CSI-RS resources corresponds to a different beam, a different transmission reception point, or both; and
receive second control information indicative of one or more CSI-RS resources from the plurality of CSI-RS resources, wherein each CSI-RS of the one or more CSI-RSs is received via a corresponding CSI-RS resource of the one or more CSI-RS resources.

13. The UE of claim 1, wherein the CSI feedback is obtained for the uplink channel in accordance with a sounding reference signal-free (SRS-free) uplink transmission procedure, and the one or more processors are individually or collectively further operable to execute the code to cause the UE to:
receive a control message that indicates the UE is to perform the SRS-free uplink transmission procedure, wherein reception of the one or more CSI-RSs is in response to reception of the control message.

14. The UE of claim 13, wherein the one or more processors are individually or collectively further operable to execute the code to cause the UE to:
receive configuration information for a plurality of uplink transmission procedures, the plurality of uplink transmission procedures comprising the SRS-free uplink transmission procedure and an SRS-based uplink transmission procedure, wherein reception of the control message is in accordance with the configuration information.

15. The UE of claim 13, wherein the one or more processors are individually or collectively further operable to execute the code to cause the UE to:
transmit capability information that indicates the UE supports the SRS-free uplink transmission procedure, wherein reception of the control message is in accordance with the capability information.

16. The UE of claim 13, wherein reception of the control message that indicates the UE is to perform the SRS-free uplink transmission procedure is based at least in part on the UE being beyond a threshold proximity to a network entity, and wherein the one or more CSI-RSs are received from the network entity.

17. The UE of claim 13, wherein the SRS-free transmission procedure comprises the uplink precoding information and the one or more MCSs being determined in an absence of one or more sounding reference signals (SRSs).

18. The UE of claim 1, wherein the one or more processors are individually or collectively further operable to execute the code to cause the UE to:
transmit the one or more uplink transmissions in accordance with the uplink precoding information and the one or more MCSs.

19. A network entity, comprising:
one or more memories storing processor-executable code; and
one or more processors coupled with the one or more memories and individually or collectively operable to execute the code to cause the network entity to:
output, over a downlink channel, one or more channel state information (CSI) reference signals (CSI-RSs);
obtain, in response to transmission of the one or more CSI-RSs, CSI feedback for an uplink channel having channel reciprocity with the downlink channel; and
output an uplink grant for the uplink channel that indicates uplink precoding information and one or more modulation and coding schemes (MCSs) to be used by a user equipment (UE) for one or more uplink transmissions over the uplink channel, wherein the uplink precoding information and one or more MCSs are calculated in accordance with the CSI feedback.

20. A method for wireless communications at a user equipment (UE), comprising:
receiving, over a downlink channel, one or more channel state information (CSI) reference signals (CSI-RSs);
transmitting, in response to reception of the one or more CSI-RSs, CSI feedback for an uplink channel having channel reciprocity with the downlink channel, wherein the CSI feedback is generated based at least in part on an uplink channel matrix derived from measurement of the one or more CSI-RSs; and
receiving an uplink grant for the uplink channel that indicates uplink precoding information and one or more modulation and coding schemes (MCSs) to be used by the UE for one or more uplink transmissions, wherein the uplink precoding information and one or more MCSs are in accordance with the CSI feedback.
